(19) United States
(12) Patent Application Publication
(10) Pub. No.: US 2021/0209546 A1
(43) Pub. Date: Jul. 8, 2021

(54) SYSTEMS AND METHODS OF BLOCKCHAIN TRANSACTION RECORDATION IN A FOOD SUPPLY CHAIN

(71) Applicant: Ripe Technology, Inc., San Rafael, CA (US)

(72) Inventors: Raja Ramachandran, San Rafael, CA (US); Philip Harris, San Rafael, CA (US); Christian Saucier, San Rafael, CA (US); Nathan Jin, San Rafael, CA (US); Francis Gouillart, San Rafael, CA (US)

(73) Assignee: Ripe Technology, Inc., San Rafael, CA (US)

(21) Appl. No.: 17/114,406

(22) Filed: Dec. 7, 2020

Related U.S. Application Data
(63) Continuation of application No. 15/940,938, filed on Mar. 29, 2018, now abandoned.
(60) Provisional application No. 62/613,683, filed on Jan. 4, 2018.
(60) Provisional application No. 62/478,582, filed on Mar. 29, 2017.

(51) Int. Cl. G06Q 10/08; G06Q 30/04

(52) U.S. Cl. CPC G06Q 10/087; G06Q 30/04

(57) ABSTRACT

Embodiments disclosed herein provide a system, method, and computer program product using blockchain and applying the internet of things concept to the food system in order to provide an infrastructure to which data can be recorded, shared and validated while data privacy and security is maintained. The collection of this data enables virtual histories of shipments to be created, which can be used to increase efficiency, create new business practices and potentially restructure marketplaces. Overall the solution presents a novel and new method to understanding of our food.

### CROSS-REFERENCE TO RELATED APPLICATIONS

This application claims the benefit of priority under 35 U.S.C. § 119 (e) from U.S. Provisional Application Ser. No. 62/478,582 filed Mar. 29, 2017 and U.S. Provisional Application Ser. No. 62/613,683 filed Jan. 4, 2018.

### TECHNICAL FIELD

This disclosure relates generally to food supply chains. More particularly, this disclosure relates to methods, systems, and computer program products relating to the use of blockchain technologies to provide an architecture and infrastructure to which food supply chain data can be recorded, shared, and validated.

### BACKGROUND

The food system is an extremely complex supply chain, moving billions of pounds of food each year. Typically, food passes through farmers, distributors, processors and retailers, often traveling thousands of miles prior to arriving in the hands of a consumer. In the process, a shipment may be split, repacked or joined with another shipment, further increasing the complexity. Given the vast and nonlinear nature of the food supply chain, the food system has become opaque, with limited traceability, information sharing, or even data collection. Several years ago, the National Resource Defense Council highlighted the need for additional data as they published the much cited statistic indicating 40% loss in the food system. Although 40% of food is wasted, the inefficiencies are difficult to identify and therefore difficult to eliminate.

Today, the food industry suffers from many of the same challenges, such as lack of data capture, concerns over data privacy, and difficulties managing inter-actor cooperation in the supply chain. Every actor in the food industry has a unique set of relevant variables, leading to patchy data sets when comparing across actors. Data, when collected, is often siloed within one actor in order to protect competitive information. Additionally, every actor utilizes a different technology platform, making data transfer difficult even when needed. Further complicating the issue is the lack of traceability. Current traceability practice is typically one step forward and one step backward as per the Bioterrorism Act of 2002, making assembling a holistic picture of a product through its lifespan extremely challenging, even for vertically integrated supply chains. A Department of Health and Human Services study found that only 5 out of 40 products could have all of their ingredients traced through the supply chain, indicating the massive dearth of information.

However, new pressure from both regulatory measures and consumers are driving change in the food supply. The Food Safety Modernization Act passed in 2010, and the subsequent rules, require increased recordkeeping and data collection along the supply chain, and recommend increased traceability measures. At the same time, consumers are increasingly demanding more information about their food, including provenance, ingredient transparency and environmental impact. These demands translate into economic value. Additionally, organic, local and non-GMO movements have been experiencing rapid growth over the past few years, and 82% of consumers believe ingredient transparency is important in making purchasing decisions. Furthermore, an Accenture study indicated improved retailer-supplier cooperation could save businesses $265 billion, demonstrating the economic benefits of increased data transfer. Sustainability is also a key driver. Consumers are demanding more transparency to quantify the negative externalities associated with food production, such as soil erosion, pesticide use, and water degradation. These pressures from every angle indicate the industry is in a key transition period for changing the way products are tracked.

### SUMMARY

A method is provided for tracking and recording data in a food supply chain system including a computer system, a plurality of sensors, one or more blockchain ledgers implemented on the computer system that interface with the plurality of sensors, tracking data relating to the food supply chain using the plurality of sensors, and storing the tracked data using the one or more blockchain ledgers.

Another embodiment provides a system, including at least one processor, and at least one non-transitory computer readable medium storing instructions translatable by the at least one processor, the instructions when translated by the at least one processor cause the system for tracking and recording data in a food supply chain system by implementing one or more blockchain ledgers that interface with a plurality of sensors, tracking data relating to the food supply chain using the plurality of sensors, and storing the tracked data using the one or more blockchain ledgers.

Another embodiment provides a computer program product comprising at least one non-transitory computer readable medium storing instructions translatable by at least one processor, the instructions when translated by the at least one processor cause a system to track and record data in a food supply chain system by implementing one or more blockchain ledgers that interface with a plurality of sensors, tracking data relating to the food supply chain using the plurality of sensors, and storing the tracked data using the one or more blockchain ledgers.

Other features and advantages of the present disclosure will be apparent from the accompanying drawings and from the detailed description that follows below.

### BRIEF DESCRIPTION OF THE FIGURES

The present disclosure is illustrated by way of example and not limitation in the figures of the accompanying drawings, in which like references indicate similar elements and in which:

FIG. 1 is a block diagram depicting an exemplary system architecture.

FIG. 2 is a block diagram depicting blockchain transaction types.

FIGS. 3A-3B are sequence diagrams for a food supply chain.

FIG. 4 is a block diagram depicting exemplary data entities.

FIGS. 5A-5B are state diagrams of an exemplary system.

FIG. 6 is a diagram depicting an exemplary web-of-trust scenario.

FIG. 7 is a diagram depicting various value outcomes and variables relating to a tomato score.

FIG. 8 is a diagram depicting an exemplary scorecard structure.

FIGS. 9-12 are diagrams depicting quality/taste data for tomatoes.

FIGS. 13-14 are diagrams relating to a blockchain of food platform.

FIG. 15 is a block diagram depicting a system architecture of a blockchain food supply system.

FIG. 16 is a functional block diagram depicting the use of food bit tokens.

FIG. 17 is a screenshot of one example of a dashboard showing a summary of data collected for a batch of produce.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a HD), hardware circuitry or the like, or any combination.

Before discussing specific embodiments, embodiments of a hardware architecture for implementing certain embodiments is generally described herein and will be discussed in more detail later. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.), or the like. In various embodiments, the computer has access to at least one database over the network.

ROM, RAM, and HD are tangible computer readable medium for storing computer-executable instructions executable by the CPU. Within this disclosure, the term “computer-readable medium” is not limited to ROM, RAM, and HD and can include any type of data storage medium that can be read by a processor. In some embodiments, a tangible computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited to only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

As described in more detail below, the present disclosure proposes a new end-to-end solution applying a software stack consisting of a blockchain, on top of which a hardware solution can plug in and upload its data along the way, creating an internet of food using sensors and other data sources. The solution described provides an infrastructure to which data can be collected in the food supply chain and recorded in a blockchain ledger, shared in the food supply chain, and validated while data privacy and security is maintained. The infrastructure described also enables applications to be created from the data and workflow and processes behind the infrastructure. The collection of this data enables virtual histories of shipments to be created, which can be used to increase efficiency, create new business practices and potentially restructure marketplaces.

Although increasing traceability and data transfer in a food supply chain results in direct economic benefits, implementation is difficult. Current solutions to tracing and data capture are constrained in capacity and are costly, limiting the adoption for an already low-margin industry. Many solutions are limited in scope, capturing data at a single point along the supply chain and often tracking only a few specific variables. A solution to the traceability and data challenges currently faced by the industry may be able to record and track the wide range of data involved with an object as it moves down the supply chain collected from a range of databases and software. Additionally, the solution is able to maintain data privacy and security while at the same time allowing data to be shared on a need-to-know basis. One exemplary solution goes beyond the capture and recording of data to provide analysis and optimization to maximize freshness, minimize waste and environmental impact, and ensure a safer, more efficient food supply chain.

One goal of the present disclosure is to reconnect the supply chain by telling the story of a product by promoting transparency along the entirety of the supply chain and assembling the histories of products as they move through the supply chain. The present disclosure proposes a new end-to-end solution applying a software stack consisting of a blockchain, on top of which a hardware solution can plug in and upload its data along the way, creating an internet of food using a combination of sensors and manual entries of data. Blockchain, sensors and the internet of things (IoT) concept complement each other, filling in each others' weaknesses to provide a robust solution set.

As mentioned above, the present disclosure proposes solutions to needs in the industry using technologies, such as distributed ledger technologies, to address the problems and challenges discussed above. Following is a brief description of blockchain technology. In some embodiments, blockchain technology may be used to implement the solutions discussed in this disclosure. Blockchain is an innovative technology protocol conventionally known to be invented in 2009 by an anonymous scientist or group of scientists using the pseudonym of Satoshi Nakamoto to support the Bitcoin network. In some embodiments, a blockchain is a distributed ledger technology in which all participants have a copy of the ledger to witness and verify transactions by themselves. Data is recorded as bundles, called ‘blocks,’ which are linked together by referencing the previous block, forming a ‘chain.’ Although current blockchain usage is limited to applications supporting bitcoin and cross-border payments, activity in the space is booming with over $1.4 billion dollars invested in blockchain companies in 2016, and over 90% of North American and European banks actively exploring implementation of blockchain technology over the next 2 years (PWC). Furthermore, organizations (both large and small) are exploring blockchain and ledger technologies to coordinate information and secure transactions across multiple industries such as insurance, health care, music, real estate, and more recently, supply chains. Useful applications of conventional blockchain technology include, for example:
Record-keeping with guaranteed historical accuracy and transparency
Contract automation based on member-approved rules and conditions
Trade facilitation among community members without a middle-man

Underpinning blockchains are accounting ledgers in a classical sense in that the ledgers allow participants in a blockchain the ability to record transactions, events and activities that are associated with each entity. The blockchain serves as the fundamental infrastructure for individual data sets to plug into, allowing for data sharing from disparate actors and technologies. Individual actors use blockchain technology as a common communication and collaboration channel, thereby allowing each participant to post and authenticate information about an activity that requires validation, such as authorizing one's identity in order to authenticate a buy-sell transaction. This validation is achieved by a consensus algorithm of trust of all parties that see the data. Security of the transaction is achieved by a series of digital, cryptographic public and private “keys” that lock and unlock records for the purpose of controlling data flow and validating authenticity.

This unification allows the blockchain to follow food products in a unique way from seed to table by recording information about a physical product as it evolves over time. For example, in some embodiments, the original data posted to the blockchain (e.g., Grower ABX seeded tomato filed 12Z on March 14) serves as a block record. As food moves along the supply chain, various types of data can be posted to the blockchain as entries in the ledger (e.g., tomatoes were harvested and packed on June 7). Another entry might record that the temperature on a truck transporting the food was 55 degrees over 274 miles traveled. These individual entries can then be associated, enriching the data associated with the shipment and essentially creating a virtual copy of the physical item. This virtual copy is the sum of the entries associated with the unique item, ultimately becoming the history of the food product through its lifecycle through the food supply chain. With this information, businesses can improve traceability, analyze environmental conditions through harvest and transportation, and gather auditable documentation on the history of a product. Additionally, retailers can track a shipment's current location and condition; food processors can better monitor storage conditions; etc. If consumers are allowed access to the data, the consumers can have visibility into data such as the grower and the grower's farming practices, food miles traveled, ripeness indicators or previews of taste.

In some embodiments, the blockchain can support multiple types of data, such as: real-time data points (e.g., ambient temperature according to a sensor, ambient humidity according to a sensor, etc.), manually entered information (e.g., genomic information about the seed, information about a famer and/or farm practices, etc.), and/or proprietary encrypted information (e.g., food preparation process), etc. In the cases where a large amount of information needs to be stored, the blockchain contains a file signature and a pointer to an external source of information (ex: an IPFS directory, USFDA records, etc.). In some examples, this information is categorized initially in an Assertions, Evidence and Certifications model. Anyone on the blockchain can post and sign an assertion, which can be associated to a unique identifier (defined below) for a bundle of produce. Assertions can be made without any evidence, but assertions for which there is evidence may command much more market power. Some evidence can be captured automatically, using sensors and IoT technology. This type of evidence will be identified and signed by the parties that handled the data capture. Other evidence can be captured manually, such as a farmer's profile, which may contain the USDA ID that confirms compliance with organic farming practices. A certification is a third party validation of an assertion, verifying its authenticity. For example, the USDA could certify that a farm is indeed organic. Detailed exemplary use cases are described below.

Blockchain technology is often described as a tamper-proof, or immutable record that protects information from being modified, removed, or misclaimed by the wrong party. Trust relationships among the system actors will grow and evolve over time and will be facilitated by an explicit network known as a web-of-trust. This web-of-trust will facilitate automation of information exchange and alerts between supply-chain participants. Blockchain technology requires multiple participants to dedicate resources in support of the blockchain. In some embodiments, the blockchain technology described herein can be hosted and supported by the member organizations involved in a particular supply-chain.

One of the more powerful features of blockchain technology is what is known as a smart contract, or an automated routine triggered by data and events on the blockchain. Smart contracts are fundamentally software algorithms that are governed by real world operating rules. Samples of smart contracts range from smart invoices where payments and or incentives are automated if contract terms are met, automating irrigation systems based on real time data, or automatic alert and rerouting of a truck in transit due to temperature issues in cargo. Numerous other examples of smart contracts are also possible, as one skilled in the art would understand. In effect, supply chain partners can create libraries of smart contracts to improve supply chain practices that are based on consensus data. Overall, participants in the blockchain benefit from lower cost, shared data management, automated risk monitoring, notification and mitigation activity, optimizations, financial settlement and cash flow improvements and compliance management.

The system described in the present disclosure presents numerous benefits. The foundational infrastructure created by the blockchain combined with the sensor and other data collected along the food supply chain has huge economic potential, as the technology set enables a decrease of inefficiencies, an unlocking of underutilized value, and the creation of new business models. Assembling a holistic picture of the lifespan of a high volume product as it passes through multiple actors on an industrial scale is unprecedented. Most attempts at something similar are academic studies focusing on a specific set of variables, or controlled in a vertically integrated supply chain. Participants in the chain are able to improve their processes, first within their own operation, and second, in their interactions and cooperation with other actors. The data sets collected can improve individual actor's operations by exposing inefficiencies and revealing insights that have not previously been recorded. For example, temperature and humidity monitoring during the transportation of a given food source can alert actors of improper handling or packing, causing the formation of a hot spot in the truck. In another example, the monitoring of moisture in a farm could help optimize water use via an irrigation system. Additionally, the creation of holistic data sets allows longitudinal correlations between events and variables both upstream and downstream. For example, new shelf life predictions can be conducted given a baseline of prior environmental conditions, allowing for more accurate estimation of lifespan and the creation of new best practices.

Whole chain traceability in a food supply chain can also radically improve food safety. Current one-step forward and backward traceability can be replaced by the ability to track through the entire chain, with associated records of labels and documentation. Being able to access the entire product journey from a single platform would eliminate the difficulty of going through the supply chain step by step, vastly improving response times in the event of a food safety incident. Additionally when a large number of objects are tracked through the blockchain, the chain could identify cross-contamination events or exposure, as well as any other incidents such as a spoiled or damaged shipment, enabling preventative action to be taken on a select group of shipments instead of a whole lot. In the case of a recall, if the root cause was identified, specific shipments downstream of the incidents could also be retrieved in a pinpointed recall, saving a company millions compared to a blanket recall. If the data sets were to be shared with consumers, post-recall brand trust and loyalty could be repaired quickly as consumers could validate and verify the claims themselves.

As mentioned above, smart contracts can also simplify and allow the automation of multiple processes between participants on the blockchain. For example, a local restaurant owner could post a smart contract on the blockchain offering to buy a set quantity of produce over a set amount of time, as long as the produce meets a certain set of specified conditions. A farmer wanting to plan his crop could bid on that contract and promise to deliver the produce at a certain price. As the produce grows and ripens, each party can be notified if growing or handling conditions exceed boundaries set in the purchase smart contract. In the case when some value is deemed to be sufficiently out-of-bound as to violate the terms of the smart contract, the produce could be redirected to other purposes, while another farmer could fill the smart contract with surplus satisfactory produce.

Adopting a longitudinal view to data collection and history in the supply chain presents the potential to restructure marketplaces by introducing new methods of valuing products. Currently fresh fruits and vegetables are brokered with minimal attached information except in the case of high-end artisanal goods. Product differentiation is left to binary labels such as organic and non-GMO which command premiums in price. However the acquisition of additional accessible data allows for new features to be verified and marketed. For example, the geo-location record could be processed by an algorithm to calculate the number of food miles traveled by a product, or the distance between the production point and point of sale in order to prove the locality of a product.

Additionally, binary labels such as conventional versus organic food products could be broken down into a spectrum of farming practices such as use of integrated pest management or no-till practices that could each garner consumer followings. These datasets and outcomes can be compiled into an index on which product is posted and sold. The index presents data in an agnostic format without taking a stance on desirability of certain aspects, and leaves it up to the user to generate a set of desired criteria to aid in purchasing and evaluation. These criteria can be compiled into a unique user scorecard, which can filter through postings and select products for desired traits. For example a restaurant may pride itself on serving local, sustainable food. The algorithm would then optimize the purchasing search for food produced within a certain radius of the restaurant, and prioritize for sustainability practices like limited pesticide use. Ultimately, this platform could create a new marketplace where purchasers buy the optimal product for their needs, while producers gain additional profit for their existing practices.

Pressure from every angle has created a perfect time for change within the food system. A low cost, secure and easy to implement solution is desperately needed to bridge the gaps in the supply chain and solve problems such as food waste, safety, quality and sustainability. The present disclosure aims to reconnect the supply chain by promoting transparency and data capture along the chain through technology. Blockchain and the internet of food complement each other to create a common collaboration platform in which data around food can be produced, tracked, validated and verified. The creation of unique histories of individual food items can solve for inefficiencies in the chain as well as create new value and business models in the system. Ultimately, the solution set offered has the potential of providing not just holistic farm-to-fork traceability, but also true understanding of our food.

### Architectural Design

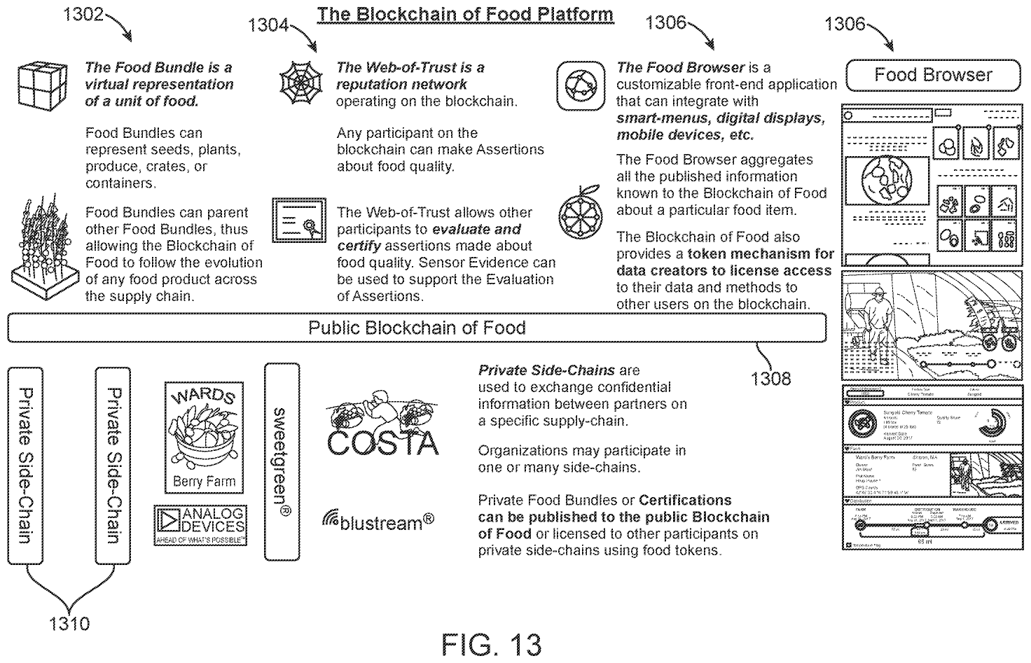

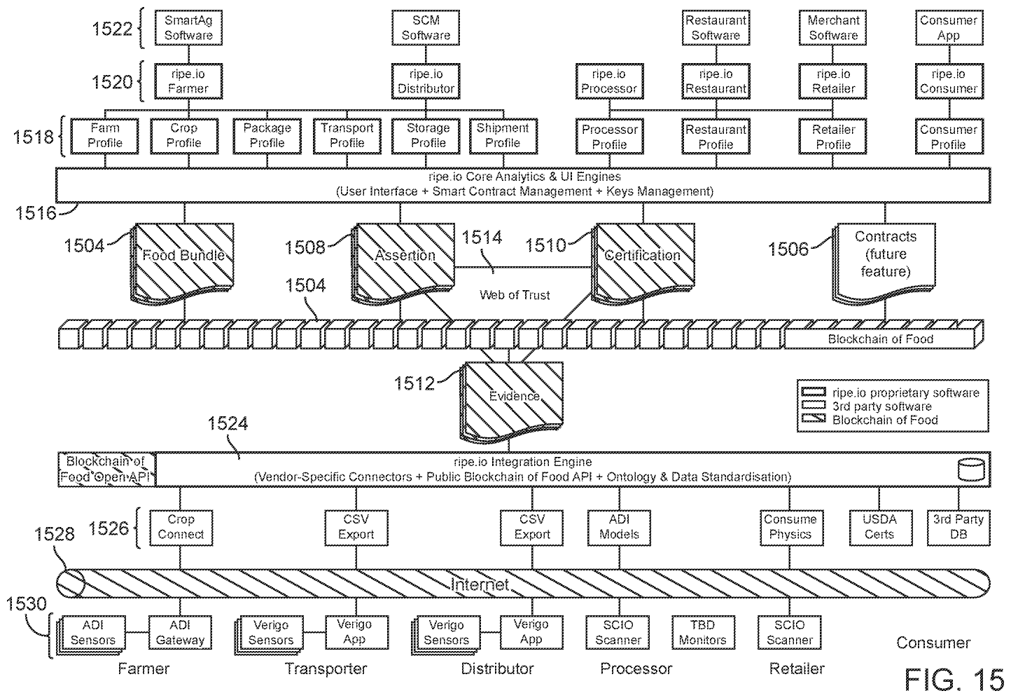

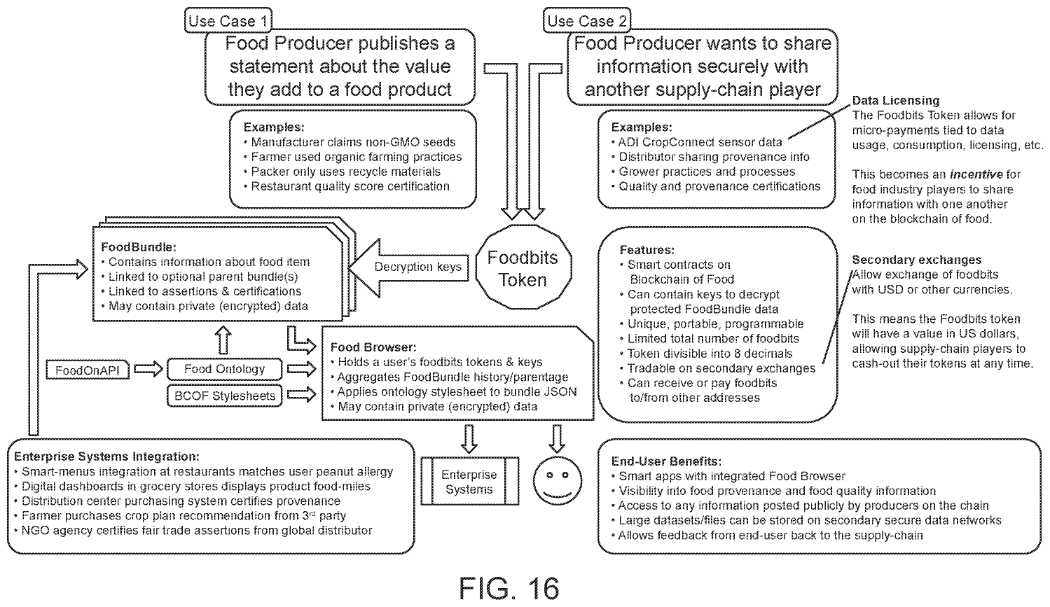

The present invention provides a common platform (FIGS. 13-16, described in detail below) where information about food can be publicly and privately exchanged among the supply chain participants. The present blockchain solution provides a decentralized repository for various types of objects, captured in signed blockchain transactions. The present invention provides that each object have a basic set of operations associated with it. These operations are to be implemented as smart contracts within the present invention's API (Application Programming Interlace) and CLI (Command Line Interface). The architecture (FIGS. 15-16, described in detail below) comprises the following components and processes: Software; Profiles; Core Analytics and UI Engines; Sensors; FOOD BUNDLES; Assertion; Web of Trust; Certification; Smart Contracts; Evidence; Integration Engine (API); and ADI Gateway.

The system described in this disclosure creates a common platform where information about food can be publicly and privately exchanged among the supply chain participants. In some embodiments, the blockchain serves as a decentralized repository for various types of objects, captured in signed blockchain transactions. Each object may have a basic set of operations associated with it. These operations may be implemented as smart contracts within the blockchain of food API and CLI.

The system uses unique identifiers, each representing a unit of food at a particular time and place along the supply chain. For the purposes of this disclosure, the unique identifiers will be referred to as “FOOD BUNDLES™”, which is a trademark of Ripe Technology, INC. FOOD BUNDLES can take many forms: bag of seeds, area of a field, specific plant, crates of fruits, pallets, etc. A bundle of food can be merged into another to form a 3rd bundle; alternately a bundle can also be separated into two or more bundles, each inheriting a selected set of characteristics from the parent bundle.

A FOOD BUNDLE transaction may have various data attached to it, such as: a version number, input counter, inputs, outputs counter, outputs, evidence counter, evidences, assertion counter, assertions, certification counter, certifications, BundleData, and signatures. A FOOD BUNDLE can be Created without or with one or many parents. Likewise, a FOOD BUNDLE can be a parent to one or many other FOOD BUNDLES. FOOD BUNDLES are created when a new unit of food is introduced into the system. FOOD BUNDLES are transferred into one or many child bundles when the physical food item changes status, container, or current holder. FOOD BUNDLES can be signed by the party that posts them to the blockchain. Transfer of ownership to a new system actor may require signing of the new child bundle by the new owners private key. Evidences, assertions, and certifications can be attached to a FOOD BUNDLE at the time the transaction is broadcasted to the blockchain. Bundle data may be captured in JSON format. This data may be structured using food categorization, measurements, and qualification, for example.

The system also uses highly deterministic identifiers representing a set of key pairs used to post transactions to the blockchain on behalf of a user or organization. User accounts can represent a seed manufacturer, a farmer, a logistics operator, a CO-OP, a restaurant, a grocer, or any other actor involved in the supply chain, for example. User account objects may be implemented as part of the blockchain engine.

In the system, “assertions” are claims made (signed) by one or multiple user accounts. Assertions can be made by anyone at any time on the blockchain. An assertion transaction may have various data attached to it, such as: a version number, input counter, inputs, outputs counter, outputs, evidence counter, evidences, certification counter, certifications, bundle counter, bundles, AssertionData, and signatures. Assertion transactions represent unique claims made by an actor in the supply chain. Assertions can be made on their own (e.g., Farmer X follows organic practices). Assertions may include a pointer to evidence transactions on the blockchain (e.g., Evidence of Farmer X organic credentials from the USDA database). Assertions may also point to certifications (e.g., self certifications or third party certifications). Assertions may be associated to one or more bundles of food on the blockchain. Assertions that evolve over time (e.g., new evidence, certifications, related bundles, etc.) may capture the new evidence by creating a child assertion transaction. Assertion data may be captured in JSON format. This can be provided in clear text, encrypted, or as a reference to an external data source (e.g., a URL, torrent id, IPFS id, etc.). Encrypted assertions can still be valued by supply chain partners who have a valid key to decrypt the data.

A certification transaction may have various data attached to it, such as: a version number, input counter, inputs, outputs counter, outputs, evidence counter, evidences, assertion counter, assertions, bundle counter, bundles, CertifcationData, and signatures. Certification transaction's present unique accreditation made by an actor in the supply chain, with reference to one's own or another's assertions. Certifications may or may not include evidence or related bundle information certifications that evolve over time (new evidence, revocation, etc.) Can capture the new status by creating a child certification transaction. Certification data may be captured in JSON format. This can be provided in clear text, encrypted, or as a reference to an external data source (e.g., a URL, torrent id, IPFS id, etc.). Encrypted certifications can still be valued by supply chain partners who have a valid key to decrypt the data.

In the system, “evidence” is a datum posted (signed) by one or multiple user accounts. Evidence can be posted manually or automatically by or on behalf of a user. An evidence transaction may have various data attached to it such as: a version number, a version number, input counter, inputs, outputs counter, outputs, EvidenceData, and signatures. evidence can be automatically captured by Internet of things sensors distributed in fields, trucks, storage facilities, etc. Evidence can also come from third-party databases to capture specific information at specific points in time. For example, evidence may include weather conditions, government accreditation, etc. Evidence data may be captured in JSON format. This data may be provided in clear text, encrypted, or as a reference to an external data source (e.g., a URL, torrent id, IPFS id, etc.). Evidence directly related to prior evidence can be stringed together through inputs and outputs (e.g., hourly temperature readings within a distribution warehouse, etc.).

In the system, “evaluation” is an assessment made (signed) by one or multiple user accounts. Evaluations bring together Assertions and Evidence under conditions associated to the user's Evaluation transaction. As described above, in the system, “smart contracts” are operations that facilitate event-driven workflows and evaluations of other blockchain transactions. Smart contracts are operations performed on blockchain objects.

Evidence posted to the blockchain will sometimes contain sensitive information that needs to be exposed to selected parties in order to perform cross-signatures and evaluations. The system described in this disclosure provides a data privacy and collaboration solution based on the “Decentralizing Privacy: Using blockchain to Protect Personal Data” whitepaper, published by Guy Zyskind (http://web.media.mit.edu/˜guyzys/data/ZNP15.pdf)

The system described in this disclosure provides a mechanism (a decentralized trust) that allows user account owners to relate to one another, building over time a verifiable trust network among participants to a particular supply chain. The system implements a “Web of Trust” based on the “Portable Reputation Toolkit, A White Paper from Rebooting the Web of Trust III Design Workshop”(https://qithub.com/WebOfTrustInfo/portable-reputation-toolkit).

Following are two exemplary use cases that exemplify the features and capabilities expected from the blockchain of food system described above. Other examples of use cases are also possible.

In a first example, a use case illustrates how the system can communicate the value of a farmer's unique practices to other users, potential customers, suppliers, etc. This exemplary use case represents the desire for a farmer to communicate the superior value of their use of Integrated Pest Management (IPM) farming practice to a restaurant chef debating between two purchase options. In this exemplary use case, the following bullet list illustrates the process that the farmer and other users may go through:

1 Farmer Brown registers fora user account on the blockchain system using the a software-as-a-service (SAAB) website.
Farmer Brown is presented with numerous account options, from a simple basic account to more complex accounts able to represent claims for sophisticated farming practices, field and storage sensors, crop maps, integrated data capture from 3rd party systems, etc. In this example, we will assume that Farmer Brown selects the simple basic account.
In the account creation form, Farmer Brown describes his location, products, unique practices, crop yield, etc. In a crop profile, Farmer Brown specifies that the crop was grown using IPM.
Farmer Brown manually creates a unique identifier (e.g., FOOD BUNDLE) representing the first manual harvest from the field. More sophisticated deployments would include field, storage, pallets, and truck sensors. In this case, with the simple basic account, Farmer Brown manually creates the FOOD BUNDLE.
Farmer Brown's profile is configured to automatically generate Assertion transactions for any FOOD BUNDLE associated with a particular crop. In this case, an Assertion transaction stating: “This FOOD BUNDLE was created using IMP practices” is signed using one of Farmer Brown's private keys and posted to the Blockchain of Food.
Farmer Brown manually creates an Evidence transactions allowing the attachment of a copy of an IPM certificate issued by a Local Farming COOP. In a more mature system, where other participants in the supply chain are also participants in the Blockchain of Food, this Evidence transaction could also have been made by an Account representing a the local farming COOP, for example.
Farmer Brown manually creates an Evaluation transaction associating his Assertion to IPM practices with the Evidence transaction(s). In one example, the system provider or other 3rd party actors could be engaged by Farmer Brown to make this Evaluation based on theft own standard. A dynamic scorecard solution is an example of this 3rd party Evaluation process.
A local Restaurant Chef is debating between two types of tomatoes from his supplier. The supplier mentions that one of the farmers, Farmer Brown, is a member of the Blockchain of Food system. The Chef connects to the Blockchain of Food to review the Assertion, Evidence, and Evaluation of Farmer Brown's use of IPM. Not having any information on the competing source, the Chef purchases the produce from Farmer Brown.

In this exemplary use case, the many transactions could each be signed and posted by different user accounts. In fact, having a farmer evaluate her own evidence about her own assertions may not make a very convincing case. However, if the evidence is captured automatically by a 3rd party vendors sensor solution, or if the evaluation is made by an independent 3rd party, the value of Farmer Brown's assertions would be even more trust worthy.

In a second example, a use case represents the need for a grocer to communicate the quality and local provenance of a locally grown bundle of food. In this example the grocer defines “local” food as anything grown within the state and having traveled less than 250 food-miles. In this exemplary use case, the following bullet list illustrates the process that the farmer and other users may go through:

Farmer Brown has a User Account on the Blockchain of Food along with a subscription to ADI Crop Connect technology (an exemplary third party entity) that captures live data about the farmer's crop.
Farmer Brown's profile and crop Assertions are automatically self-evaluated by Farmer Brown using evidence posted by ADI Crop Connect to the Blockchain of Food.
The system captures the farmers self-evaluation and co-signs specific evaluations related to geo-location evidence posted by the ADI Crop Connect system.
John the Trucker comes by Farmer Brown's farm to pick up the latest crop.
John the Trucker has a profile on the Blockchain of Food that automatically posts an Assertion that the food is transported under acceptable conditions, meaning within desired temperature, humidity, and time constraints.
The Verigo solution (an exemplary third party entity) captures data from sensors on the food pallets as John the Truck delivers the shipment to the Retailer.
The Verigo sensors post Evidence of Temperature, Humidity, Geolocation, and Shock to the Blockchain of Food.
John the Truckers profile automatically self-Evaluates his Assertions by linking them to available Evidence.
The Retailer's receiving associate validates that John the Trucker's Assertions and self-Evaluation are within contractually accepted ranges.
The Retailer accepts the shipment and moves selected pallets to the retail floor.
A floor associate updates the Price, Description, and Blockchain of Food QR Code for the associated product.
A consumer using the retailer's proprietary smart-phone application is able to scan the Blockchain of Food OR Code and get proof of the product's origins.

Terminology may be important to the success of the system described in the present disclosure. To ensure interoperability between Assertions, Evidence, Evaluations, and other Smart Contracts, in some embodiments, the system will provide 2 levels of data structure: 1) Mandatory Transaction Records, and 2) Optional Ontology for Food Description. Blockchain transactions will follow strict structure and nomenclature based on the API and blockchain protocol. In some examples, these transactions may follow a defined JSON (JavaSript Object Notation) format posted using traditional RPC (Remote Procedure Call) network connections. Within certain blockchain transaction records, specific food elements and attributes may be described. In order to facilitate interoperability, these descriptions are encouraged to follow a recommended lexicon and ontology.

The system described above may be implemented in any desired manner, as one skilled in the art would understand. In some examples, the system may be comprised of three phases, including a scorecard phase, a supply automation phase, and a smart marketplace phase. In some embodiments, the system uses sensor data captured on a blockchain to generate a produce scorecard that will improve the understanding of risks and inefficiencies across a supply chain. Detailed examples of a produce scorecard are provided below. The system uses smart contracts (described above) stored on the blockchain to provide near real-time alerts and can automate provisioning decisions based on sensor data and scorecard results. Members of the system community can use the blockchain to communicate product availability and purchasing contracts with quality and ripening conditions monitored on the blockchain.

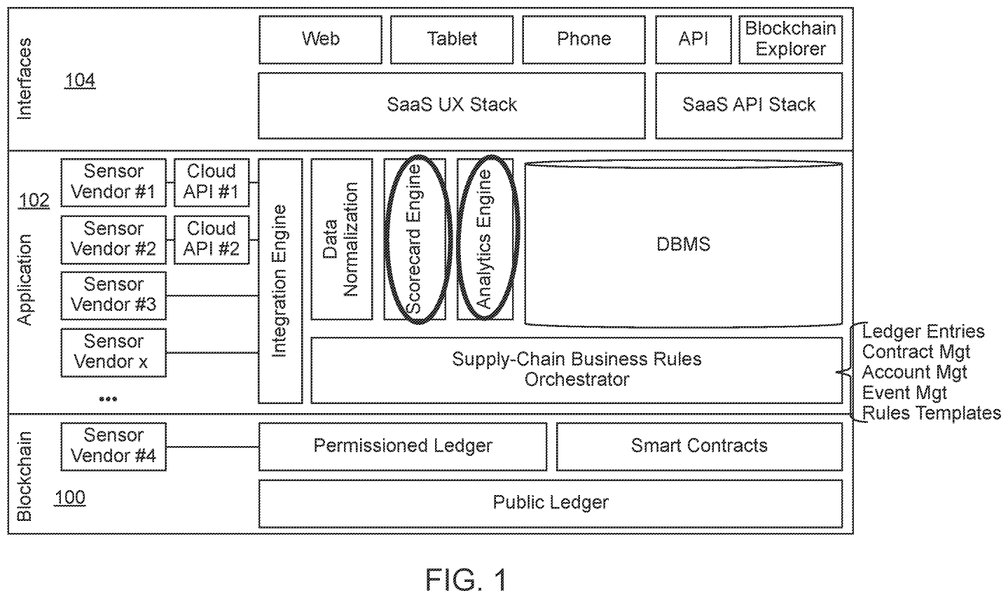

FIG. 1 shows an exemplary system architecture diagram. In FIG. 1, a blockchain section 100 shows a public ledger, a permissioned ledger, smart contracts, and a sensor vendor. An application section 102 shows a supply-chain business rules orchestrator, an integration engine operatively coupled to various sensor vendors and cloud API's. The application section 102 also shows data normalization, scorecard engine, and analytics engine blocks, as well as a database (DBMS). An interfaces section 104 shows software as a service (SaaS) UX stack that can interface with web, tablet and phone devices and a SaaS API stack and corresponding API and blockchain explorer blocks.

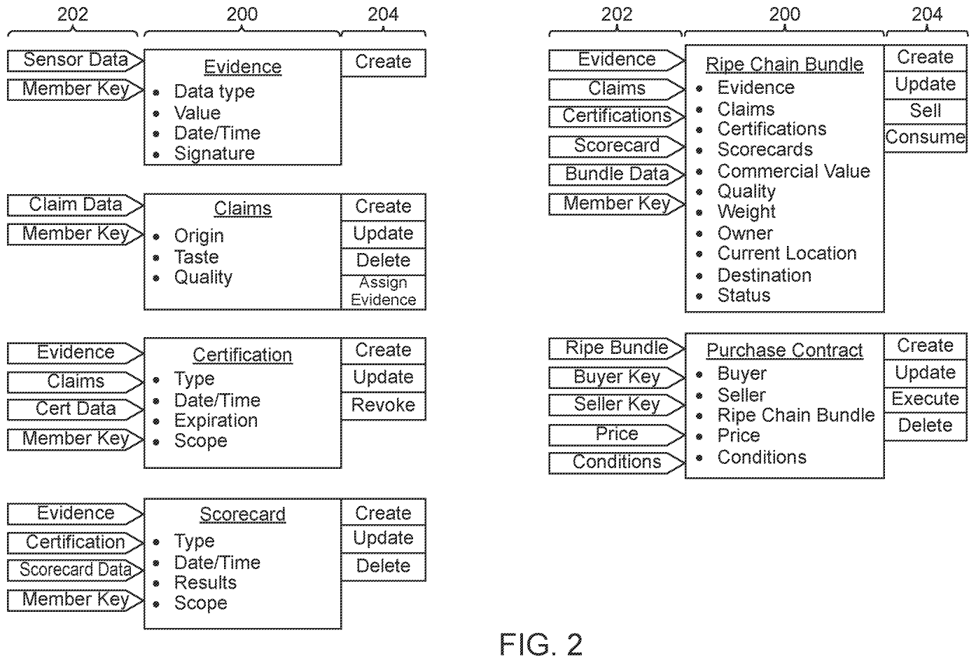

FIG. 2 shows various exemplary blockchain transaction types 200, including evidence, claims, certification, scorecard, ripe chain bundle, and purchase contract. Each transaction type 200 shown in FIG. 2 includes exemplary transaction parameters. For example, Evidence transaction 200 lists parameters such as data type, value, date/time, and signature. Claims transaction 200 lists parameters such as origin, taste, and quality. Certification and Scorecard transactions 200 lists parameters such as type, date/time, expiration, and scope. Chain bundle transaction 200 lists parameters such as evidence, claims, certifications, scorecards, commercial value, quantity, weight, owner, current location, destination, and status. Purchase contract transaction 200 lists parameters such as buyer, seller, chain bundle, price, and conditions. FIG. 2 also illustrates various inputs 202 that may be provided to a given transaction. Exemplary input data 202 includes sensor data, member key, claim data, evidence, certification, scorecard data, bundle data, food bundle, buyer key, seller key, price, conditions, etc. FIG. 2 also illustrates various functions 204 that may be performed for a given transaction type. Exemplary functions 204 include create, update, delete, assigned evidence, revoke, sell, consume, etc.

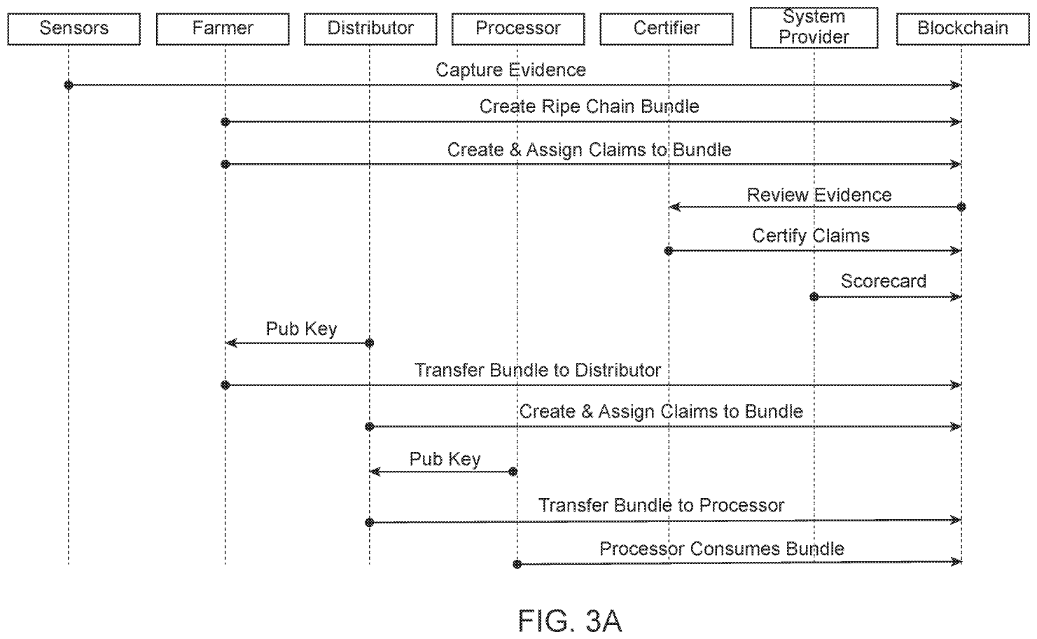

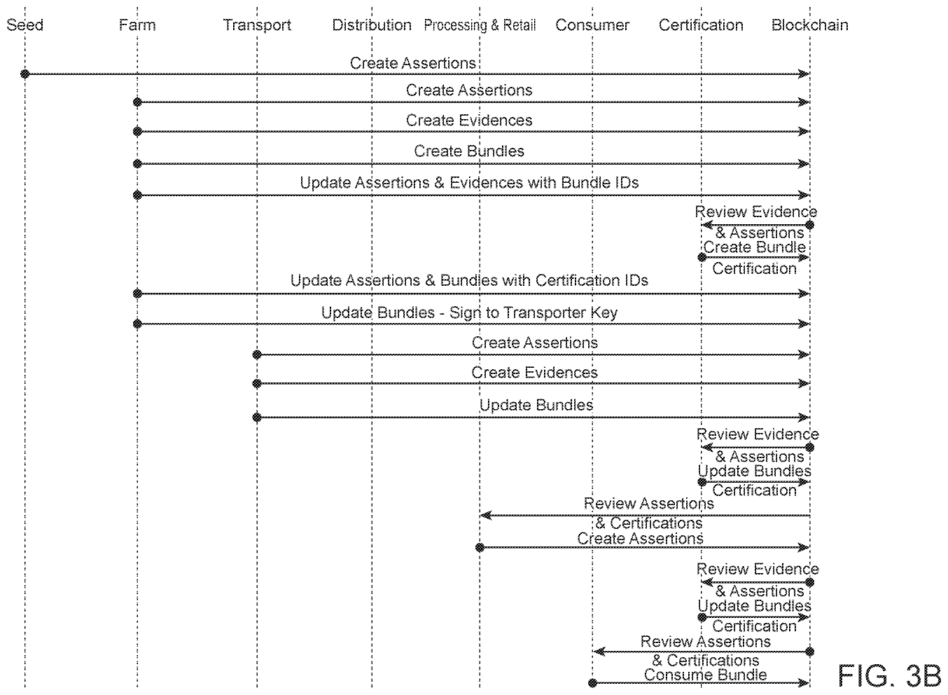

FIGS. 3A and 3B show two examples of sequence diagram for the system. FIG. 3A shows various components of a food supply chain, including sensors, a farmer, a distributor, a food processor, a certifier, a system provider, and the blockchain. FIG. 3A also shows various items and how the items are used by the various components of the food supply chain. For example, the sensors capture evidence which is provided to the blockchain. The farmer creates a chain bundle and provides it to the blockchain. The farmer also creates and assigns claims to the bundle, which is provided to the blockchain. The blockchain provides review evidence to a certifier, so that the certifier can provide certified claims to the blockchain. The system provider provides a scorecard to the blockchain for a given bundle. The distributor provides a public key to the farmer. The farmer transfers a bundle to the distributor and provides related information to the blockchain. The distributor creates and assigns claims to the bundle and provides related information to the blockchain. The food processor provides a public key to the distributor. The distributor transfers the bundle to the food processor and provides related information to the blockchain. The food processor consumes the bundle and provides related information to the blockchain.

FIG. 3B shows another example of a sequence diagram similar to FIG. 3A. FIG. 3B shows various components of a food supply chain from a seed to the blockchain, including a farm, transportation, distribution, processing and retail, consumer, and certification. Like FIG. 3A, FIG. 3B also shows various items and how the items are used by the various components of the food supply chain. For example, assertions are created for a given seed and provided to the blockchain. At the farm, assertions, evidences, and bundles are created and provided to the blockchain. At the farm, update assertions and evidences with bundle IDs are provided to the blockchain. Similarly, update assertions and bundles with certification IDs are provided to the blockchain. Similarly, update bundles are also provided to the blockchain with a transporter key. The blockchain provides review evidence and assertions to a certifier, which creates bundle certifications and provides them to the blockchain. The transportation system creates assertions, evidences, and update bundles and provides the information to the blockchain. The blockchain provides review evidence and assertions to the certifier, which creates update bundles certification to the blockchain. The processing and retail system receives review assertions and certifications from the blockchain and creates assertions which are provided back to the blockchain. In response, the blockchain again provides review evidence and assertions to the certifier, which creates update bundles certification to the blockchain. The consumer receives review assertions and certifications from a blockchain and provides a consume bundle to the blockchain.

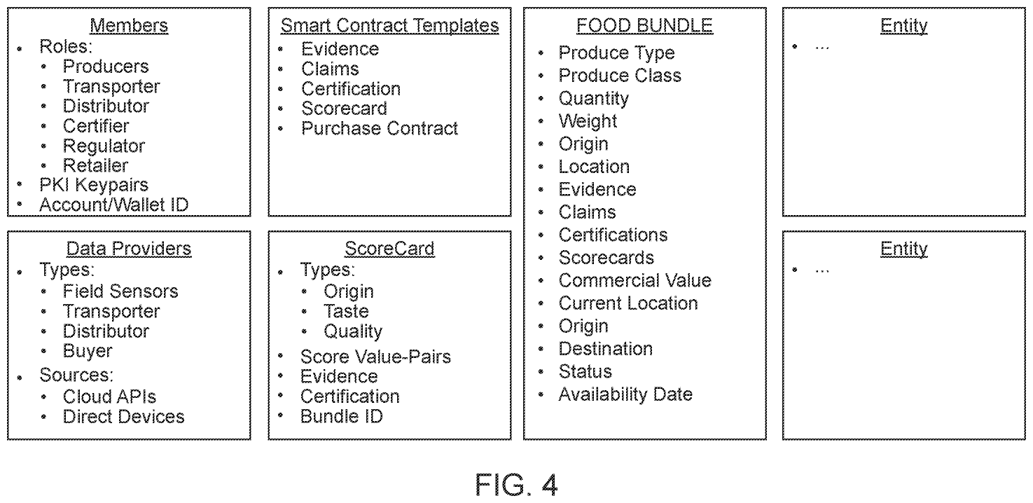

FIG. 4 shows a diagram of architecturally significant data entities. In this example, the data entities shown include members, data providers, smart contract templates, scorecards, FOOD BUNDLES, and other entities. For each exemplary data entity, various examples and parameters are listed. Any other desired type of data entity may also be used, as one skilled in the art would understand.

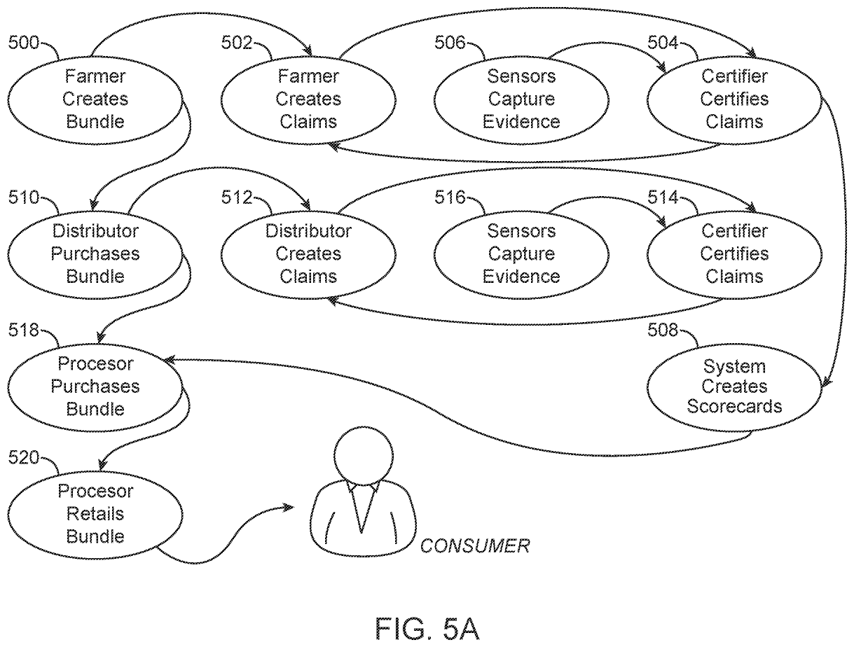

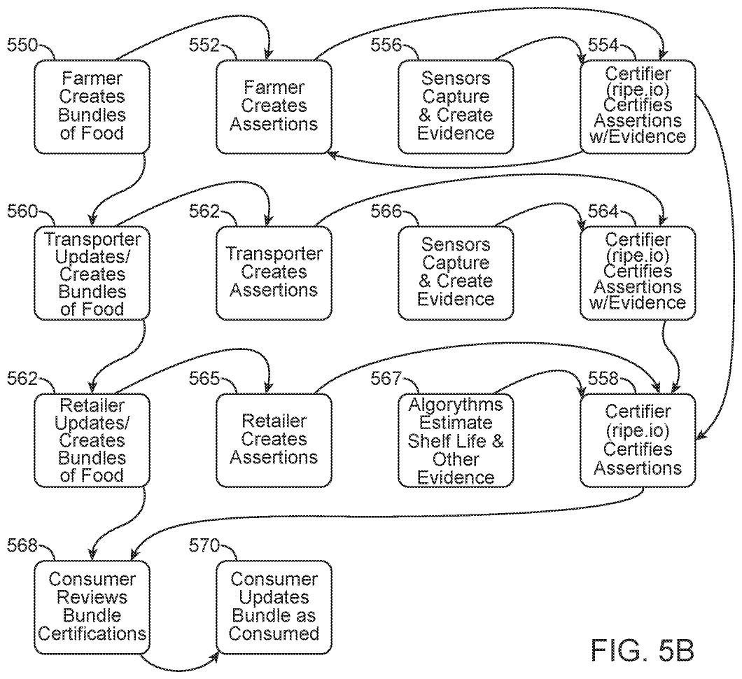

FIGS. 5A-5B show state diagrams of an exemplary system. The state diagram of FIG. 5A begins with a farmer creating a food bundle 500. Next, the farmer creates claims 502 relating to the created food bundle. The claims are provided to a certifier who certifies the claims 504. Along with the claims, the certifier uses evidence captured by sensors 506. The certified claims are provided back to the farmer, as well as to the system, which creates scorecards 508. When the farmer creates the food bundle, it is also provided to a distributor that purchases the food bundle 510. The distributor creates claims 512 and provides the claims to the certifier. The certifier also receives evidence captured by sensors 516 and certifies these claims 514. The certifier provides certified claims back to the distributor, as well as to the system. The distributor also provides information to the processor which purchases the bundle 518. The processor also retails the bundle 520 which is ultimately provided to consumers 522. With the information available to consumers, a consumer gains greater visibility into food provenance, quality, and safety.

FIG. 5B is similar to the state diagram of FIG. 5A, but shows a process using a retailer selling to a consumer. The state diagram of FIG. 5B begins with a farmer creating a FOOD BUNDLE 550. Next, the farmer creates assertions 552 relating to the created food bundle. The assertions are provided to a certifier who certifies the assertions with evidence 554. Along with the assertions, the certifier uses evidence captured and created by sensors 556. The certified farmer assertions with evidence are provided back to the farmer. The certified farmer assertions with evidence are used by the certifier along with other input (retailer assertions, certified transporter assertions, and other evidence) to certify the retailer assertions 558. When the farmer creates the food bundle, it is also provided to a transporter, which updates/creates the FOOD BUNDLES 560. The transporter creates assertions 562 and provides the assertions to the certifier. The certifier also receives evidence captured and created by sensors 566 to certify the transporter assertions 564. The transporter also provides information to the retailer which updates/creates BUNDLES OF FOOD 562. The retailer also creates assertions 565, which are provided to the certifier. The certifier also receives as input estimated shelf life and other evidence determined by algorithms 567 to certify the retailer assertions 558 (as mentioned above). A consumer receives information from the retailer and the retailer certified assertions from the certifier and then reviews the bundle certifications 568. Finally, the consumer updates the bundle as consumed 570.

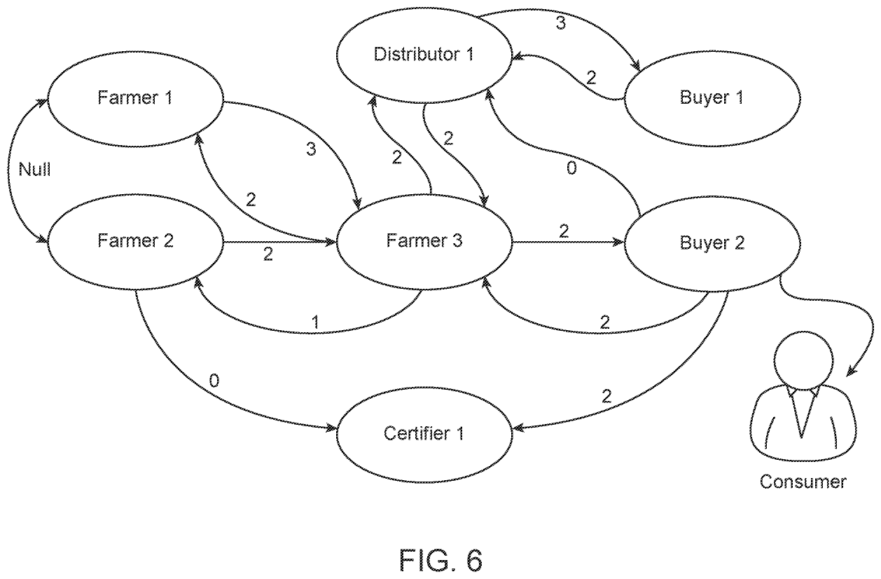

FIG. 6 shows a state diagram of an exemplary web-of-trust scenario. Web-of-trust is maintained among members using member-encrypted wallets. Web-of-trust allows for automation of certain processes and contracts among trusted members. In some embodiments, web-of-trust levels include (and are labeled in FIG. 6):
Null: Unknown
0: Do not trust
1: Trust (manual confirmation required)
2: Strong Trust (automated transactions)
3: Ultimate Trust (strong trust+introducer)

In the exemplary scenario illustrated in FIG. 6, the system acts as a system-wode trusted certifier. Other certifying agencies can join the system (e.g., regulator, industry standards, etc.). In the exemplary scenario illustrated in FIG. 6, the following relations are shown:
Farmer 3 acts as a distributor to Farmers 1 & 2
Farmer 3 will buy bundles from Farmer 2 with manual confirmation
Farmer 3 will buy bundles from Farmer 1 automatically if procurement contract conditions are met
Farmer 1 would automatically sell bundles to Distributor 1 if procurement contract conditions are met, based on Introducer trust level with Farmer 3
Farmer 2 does not trust claims certified by Certifier 1, which prevents any contract automation The Consumer has visibility into food origins, product quality, ripeness, and safety.

The system described above has numerous applications, as one skilled in the art would understand. One exemplary implementation is to develop a value scorecard for a given product. For example, a scorecard can be developed for a tomato or batch of tomatoes grown by a farmer. In one example application, a combination of blockchain and sensors/Internet of Things technology aims to compute a fair price for tomatoes at each stage of their development and eventual consumption. The same concepts can be applied to other types of produce as well. Typically, the amount of information available on a given tomato is limited. Usually, little is known about a given tomato, beyond its physical appearance and some basic labeling information that accompanies it. As a result, tomatoes (and other types of produce) are priced inefficiently all along the food supply chain. There are no tools available needed to reward quality or penalize mediocrity, and by default, markets price tomatoes as commodities. One goal of the disclosed system is to create transparency on the intrinsic value of a tomato, which will allow more efficient pricing of the tomato. Another goal of the system is to allow each stakeholder the food supply chain to develop new processes and practices that increase the value of their tomatoes. Both goals require building a model of what constitutes value for a tomato at its various stages of development. For the purposes of this description, this model referred to as a “tomato scorecard”.

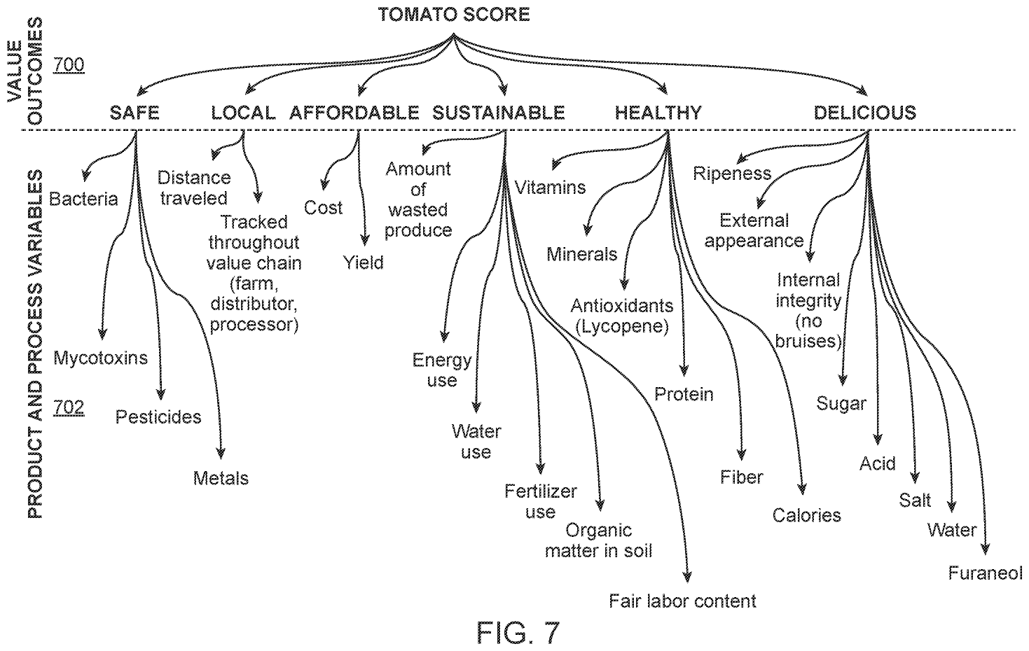

In one exemplary embodiment, a tomato scorecard has a score driven by a plurality of value outcomes, with each value outcomes being driven by a set of product and process variables. FIG. 7 is a diagram illustrating one example of value outcomes and product and process variables are used in determining a tomato score. This exemplary scorecard is built by developing a score for six value outcomes 700. In this example, the six value outcomes include “safe”, “local”, “affordable”, “sustainable”, “healthy”, and “delicious”. The meaning of these value outcomes are self-explanatory. For example, deliciousness relates to taste, while safety and health relate to nutrition. An overall tomato score is computed as the combination of the individual scores of these six value outcomes. Users of the system will have a choice of using a single aggregate score, which is determined by an algorithm using an established normative weighting of each attribute. Alternatively, users of the system may define their own weighting of attributes to match their unique needs or preferences.

FIG. 7 also shows various product and process variables 702 associated with a given value outcome 700. In the example shown, 28 product and process variables are used. For example, to determine value outcome “safe”, the product and process variables include bacteria, mycotoxins, pesticides, and metals. Each of these variables relate to the safety of food. Similarly, to determine the value outcome “local”, the product and process variables include distance traveled and tracking information throughout the supply chain. To determine the value outcome “affordable”, the product and process variables include cost and yield. To determine the value outcome “sustainable”, the product process variables include amount of wasted produce, energy use, water use, fertilizer use, content of organic matter in the soil, and fair labor content. To determine the value outcome “healthy”, the product and process variables include vitamins, minerals, antioxidants, protein, fiber, and calories. To determine the value outcome “delicious”, the product and process variables include ripeness, appearance, internal integrity, sugar, acid, salt, water, and furaneol.

The score of each value outcome 700 is measured to the aggregation of the respective set of product or process variables. As before, a user of the system will have a choice of using a provided standard algorithm or developing their own weighting of variables based on their unique needs or preferences.

Typically, there are five major stakeholders involved in buying or selling tomatoes. The stakeholders include farmers, distributors/aggregators, processors/kitchens/food service or food companies, retailers, and consumers. Conceptually, a tomato is continuously adding or subtracting value at any moment of its development over the food supply chain. For example, as a tomato grows from seed to plant ripe fruit, it gradually improves its nutritional value, taste, yield, etc. At any given time, a tomato may also lose value because of drought or flood, becoming less safe due to pollutants, attacked by pests that reduce yield or require pesticides, etc. While the major stakeholders will be able to continuously monitor the progress of a given tomato on the scorecard, the scorecard may have its greatest utility when the tomato is bought or sold. The tomato scorecard can be used to influence the price set in a tomato transaction, wherever he scorecard is available.

For example, a farmer may use a tomato scorecard to the attempt to add value through a farming process where multiple decisions are made between a buy and sell transaction. For example, during a buy transaction, a farmer may make determinations based on various factors such as:
Select and buy seed (which seed should I use?)
Test and fertilize soil (do need fertilizers? Which ones?)
Scout field (do I have a problem with pests?)
Plant and grow seed in greenhouse (is my plant growing as it should?)
Transfer and grow plant in field (how apart and how deep should I plant?; is my plant or fruit growing as it should?)
Irrigate (do I need to apply water?)
Apply pesticides (6A. herbicide, 6B. insecticide, 6C. fungicide) (do I need to spray? With what products?)
Harvest (is it the right time for harvest?)
Store and pack (when should I sell?)

Similarly, during a sell transaction, a farmer may make determinations relating to marketing, pricing, and selling produce (What customer should I sell to? At what price?). Each decision made by the farmer impacts (positively or negatively) were more product or process variables, which in turn drive the value outcomes. For example, applying pesticides may improve the yield and affordability score, but will negatively impact the sustainability score and possibly even the safety score. Some cause-and-effect relationships between a stakeholder decision, product and process variable, and value outcome may be trivial. For example, it is known that irrigating is usually a good thing in that it improves yield, health/nutrition, and taste. Other cause-and-effect relationships may be unknown and will have to be discovered through actual data made possible by the system described in this disclosure. Generally, the link between agricultural practices of the farmer and taste is largely unknown. For example, what is the relationship between soil characteristics and taste of the finished product? Does the acidic soil healed acidic tomatoes? Does a salty soil healed salty tomatoes? There are also many micro-practices yet to be discovered. For example, how much does the sugar of a tomato increase as it is being cooked? Should the tomato be left to ripen off the vine for a few days after harvest before being transported? What is the optimal spacing between tomato plants? How deep should the seeds be planted for maximum yield? How can we tell that a tomato is at its ripening Peak? It would be advantageous for farmers to investigate contextual causes and effects of their farm. For example, what type of tomatoes should be planted in a given area of the field, given that area's unique soil or sun exposure?

Distributors can add value through a four step process (for example) in which they make multiple decisions bracketed by a buy and a sell transaction. For example, in a buy transaction the distributor will want to determine which tomatoes to buy, what price to buy it, when to buy, and from whom to buy. Following are four exemplary process steps that a distributor may use:
Inbound transportation (What mode of transportation? What carrier?)
Pack/store/warehouse (What allocation of space between produce? What packaging?)
Preparation (e.g., wash, cut, peel, bunch, mix) (Should I do any value-added preparation? Which type?)
Outbound transportation deliver (What routes? With what equipment?)

Similarly, during a sell transaction, a distributor may make determinations relating to whom to sell to, what price to sell, and with what frequency of delivery.

Retailers may also have a specific process and set of decisions between a buy and a sell transaction. For example, for a buy transaction, the retailer may want to determine what tomatoes to buy, at what price to buy, and from whom to buy. Following are two exemplary process steps that a retailer may use:
Receive and store (when to accept shipment, where and how to store?)
Put on display, label, replenish shelves (what type of display, what label, next to what?)

Similarly, during a sell transaction, a retailer may make decisions relating to at what price to sell, what specials to offer, and what promotions to offer. At each step in the distributor and retailer processes, a given tomato increases or decreases in value as a result of each decision made.

Processors such as foodservice companies, food companies, or commercial kitchens can add value through a five-step value-adding process (for example) bracketed by a buy and a sell transaction. For example, in a buy transaction, the processor will want to determine what tomatoes to buy, at what price, and from whom. Following are five exemplary process steps that a processor may use:
Inbound transportation (What mode of transportation? What carrier?)
Receive and store (How to manage inventory?)
Preparation (e.g., wash, cut, peel, bunch, mix) (Should I do any value-added prep? Which type?)
Design menu, cook, assemble, serve (what recipe? what menu?)
Dispose of waste (what to compost? frequency of pick-ups? how to reap value for waste? etc.)

Similarly, during a sell transaction, a processor may make determinations relating to what price to sell for a dish or what to offer in combination with what.

Consumers have a relatively simple four-step (for example) process. For example, in a buy transaction, the consumer will want to determine whether to buy a tomato, whether to buy a fresh tomato, or whether to buy a processed tomato or product or dish. Following are four exemplary process steps that a consumer may use relating to a purchased tomato:
Store in their home
Prepare in recipe
Eat (when to eat produce for optimal ripeness)
Dispose of waste (when to decide to trash, how to dispose of wasted product)

A consumer will typically not have a sell transaction, but a measure of customer satisfaction is important to the major stakeholders involved in buying or selling tomatoes. In summary, the value of the tomato increases or decreases as a result of what processors and consumers do in their process.

Depending on the type of produce, it may be desirable to build different value models for the different types of produce. For example, using the example of tomatoes, there are four different types of tomatoes on the market: cherry and great tomatoes, field or vine tomatoes, plum tomatoes, and heirloom tomatoes. Each of these types themselves could also be segmented into multiple sub-segments, if desired. Each of these types of tomatoes have different growth processes and value characteristics. For example, some tomatoes, such as field tomatoes, will grow all year long (“indeterminate” tomatoes), while others ripen all at the same time (e.g., plum tomatoes, “determinate” tomatoes). Also, consumers may value different things. For example, a consumer may value cherry and grape tomatoes, because they are consumed fresh, and are valued for their sugar. In another example, Plum tomatoes all come at once in the fall and are used for processing, so they must contain as little water as possible. In another example, the physical appearance of heirloom tomatoes, including their color, is disproportionately important to create a rainbow of colors in the display or the salad being offered.

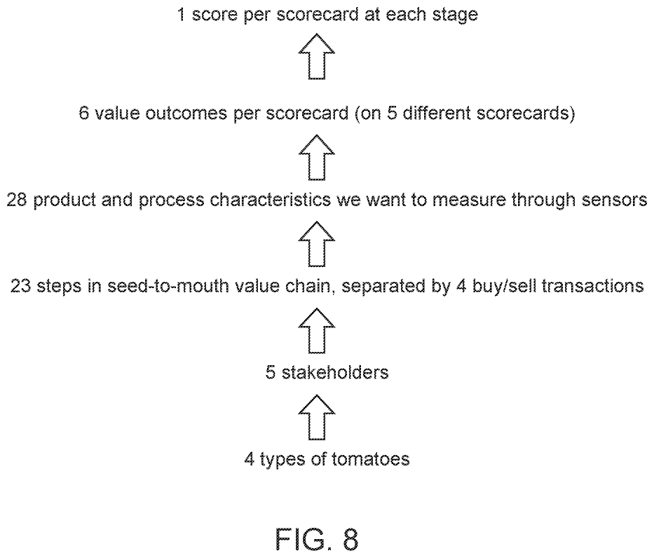

FIG. 8 shows an exemplary scorecard structure. In one embodiment, a tomato scorecard will have one score per scorecard at each stage of the supply chain. Each of the five scores is determined using six value outcomes per scorecard (see FIG. 7). The six value outcomes are determined based on the 28 product and process characteristics that are determined (for example, via sensors). In one example, there are 23 steps in seed-to-mouth value chain, separated by four buy/sell transactions. The value chain involves the five major stakeholders described above. All this is determined for each of the four types of tomatoes, if desired.

As described above, the disclosed system provides detailed information about products throughout the entire supply chain. Any user of the system can analyze the data and use the results to improve various aspects of the supply chain. For example, in the context of tomatoes, the data can be analyzed to determine optimal factors relating to the taste and quality of tomatoes. For example, by analyzing the conditions to which the best tomatoes (e.g., quality, taste, etc.) were exposed, growers, distributors, processors, consumers, etc., can attempt to optimize conditions to maximize tomato quality, increase efficiency, minimize waste, etc.

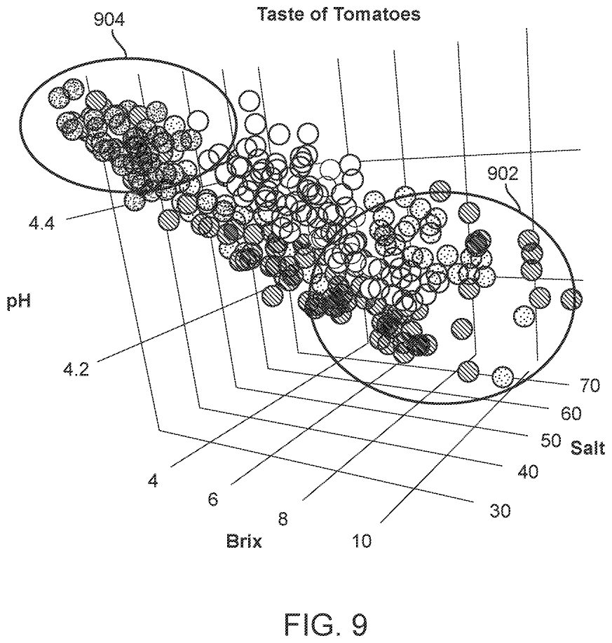

For example, the taste/quality of a tomato is affected by sweetness (e.g., Brix value), acid level (e.g., pH), and salt. FIG. 9 is a 3D plot illustrating the taste of various tomatoes as a function of acidity (pH), sweetness (Brix), and salt. In the example of FIG. 9, assume that line 902 generally encompasses locally grown tomatoes, and line 904 generally encompasses non-local tomatoes. Also assume that the area in the proximity of line 902 represents pH/Brix/Salt levels corresponding to better tasting tomatoes than does the area in the proximity of line 904. One can conclude from this data that local tomatoes taste better than non-local tomatoes. A user can look at various other data to determine why (e.g., time since harvest, ripeness, soil types, farming practices, shipping/storage conditions, weather conditions, etc.). By analyzing this type of data, a user can learn how to optimize various conditions in the food supply chain.

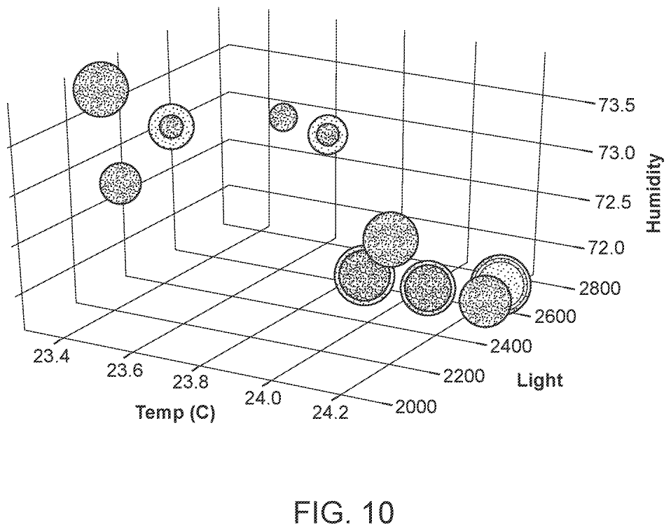

In another example, the taste of tomatoes can be correlated to environmental conditions. FIG. 10 is a 3D plot illustrating some environmental conditions (temperature, light, humidity) for a given number of tomatoes. Since the system includes data regarding the taste of the tomatoes, a user can determine how these environmental conditions affect the taste. Using the data from the exemplary plot of FIG. 10, it was concluded that desirable taste is driven by higher temperature, more light, and lower humidity. From this data, users can make more educated decisions in the supply chain.

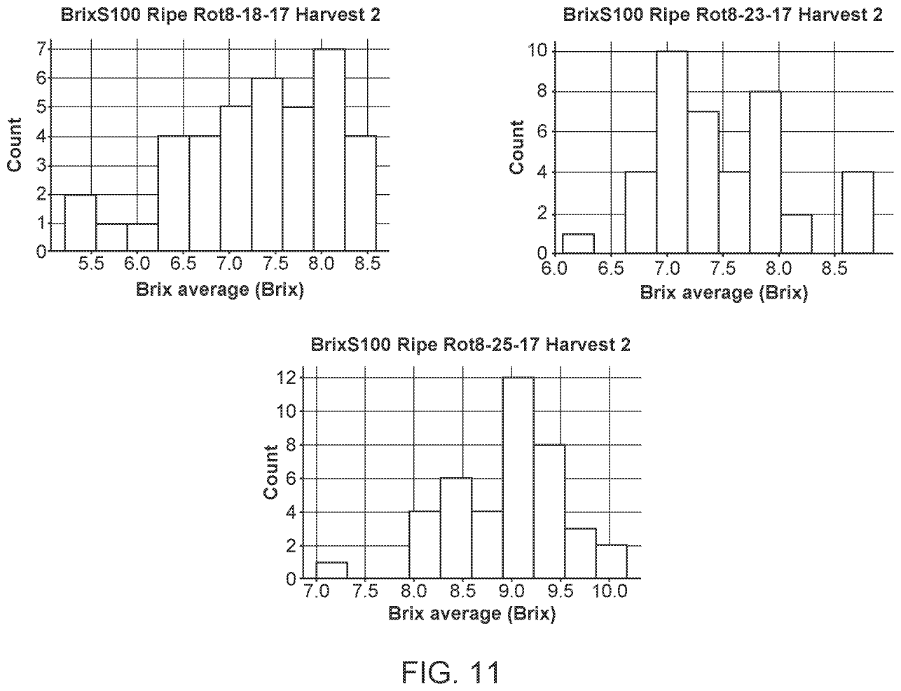

In another example, the sugar content (sweetness) of tomatoes can be correlated to conditions such as the time since harvest. FIG. 11 shows a series of charts for three tomato harvests illustrating the sugar content (Brix average) versus the days since harvest. As shown in all three charts, the taste (sweetness/acidity/salt) improves in the days immediately after harvest. From this data, a user can conclude that they should let tomatoes age at room temperature for a few days after harvest. This information can be used by any stakeholders in the food supply chain to optimize their operation, for example, by timing harvests, transports, orders, etc.

Note that, the same type of data can be tracked to individual tomatoes (using shared data from farms, sensors, etc.) to attempt to understand factors such as the consistency the ripening process, etc.

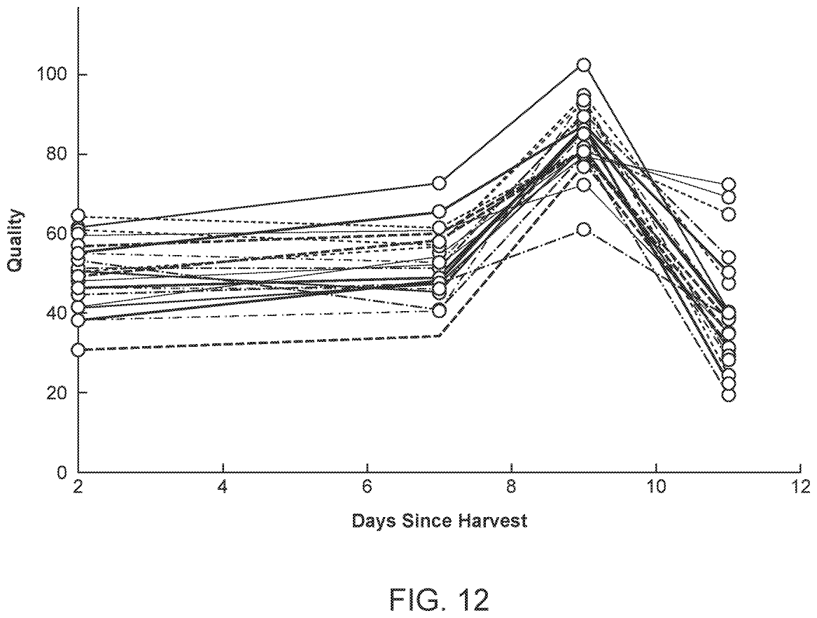

In another example, the overall taste quality of a particular tomato variety from a grower can be correlated to the time since harvest. FIG. 12 shows a plot of the overall taste quality of a particular variety of tomatoes from a given grower versus days from harvest. Based on this data a user can conclude that the tomatoes peak in quality about 9 days after harvest. From this information, food supply stakeholders can attempt to optimize their operations to maximize produce quality. For example, rather than delivering produce as soon as possible, sometimes it may be desirable to schedule deliveries based on knowledge of ripeness. Similarly, a processor or consumer may select produce based on the optimal ripeness, rather than merely freshness.

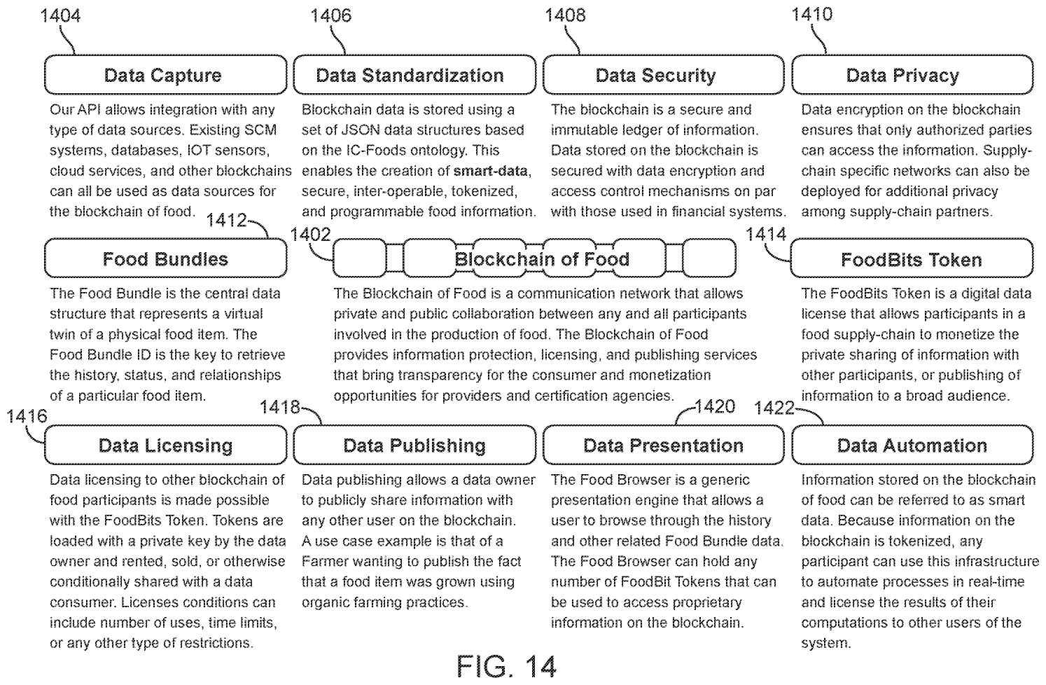

As mentioned above, FIGS. 13-14 relate to a common platform where information about food can be publicly and privately exchanged among the supply chain participants. The present blockchain solution provides a decentralized repository for various types of objects, captured in signed blockchain transactions. The present disclosure provides that each object have a basic set of operations associated with it. These operations are to be implemented as smart contracts within the present invention's API (Application Programming Interface) and CLI (Command Line Interface). The blockchain platform represented in FIG. 13 generally comprises FOOD BUNDLES 1302 (described in detail above), a web-of-trust reputation network 1304 (described in detail above), and a food browser 1306. The food browser 1306 is a customizable front end application that can integrate with smart menus, digital displays, mobile devices, etc. The food browser aggregates all the published information known to the blockchain of food about a particular food item. The blockchain of food also provides a token mechanism for data creators to license access to their data and methods to other users on the blockchain. FIG. 13 also illustrates a public blockchain of food 1308 and private side-chains 1310. Private side-chains are used to exchange confidential information between partners on a specific supply-chain. Organizations may participate in one or many side-chains. Private FOOD BUNDLES or certifications can be published to the public blockchain of food or licensed to other participants on private side-chains using food tokens.

FIG. 14 is a chart illustrating various components of a typical blockchain of food. As shown, the blockchain of food 1402 is a communication network that allows private and public collaboration between any of all participants involved in the production of food. The blockchain of food provides information protection, licensing, and publishing services that bring transparency for the consumer and monetization opportunities for providers and certification agencies. A data capture component 1404 uses an API that allows integration with any type of data source. Existing SCM systems, databases, Internet of things sensors, cloud services, and other blockchain's can all be use as data sources for the blockchain of food. A data standardization component 1406 ensures that data from disparate sources can be used. Blockchain data is stored using a set of JSON data structures based on the IC-foods ontology this enables the creation of smart data, secure, interoperable, tokenized, and programmable food information. To prevent the requirement of users conforming to a standard, the system is capable of mapping user data to a common data structure. A data security component 1408 maintain security. The blockchain is a secure and immutable ledger of information. Data stored in the black chain is secured with data encryption and access control mechanisms on par with those used in financial systems. A data privacy component 1410 enables data encryption on the blockchain to ensure that only authorized parties can access the information. Supply chain specific networks can also be deployed for additional privacy among supply chain partners. As described above, a food bundle is a central data structure that represents a virtual twin of a physical food item or items. A food bundle component 1412 uses a food bundle ID as a key to retrieve the history, status, and relationships of a particular food item. A foodbit token 1414 is a digital data license that allows participants in the food supply chain to monetize the private sharing of information with other participants, or publishing of information to a broad audience. A data licensing component 1416 enables data licensing to other blockchain of food participants and is made possible with foodbit tokens. Tokens are loaded with a private key by the data owner and rented, sold, or otherwise conditionally shared with a data consumer. License can include the number of uses, time limits, or any other type of restriction. A data publishing component 1418 allows a data owner to publicly share information with any other user on the blockchain. A use case example is that of a farmer wanting to publish the fact that the food item was gone using organic farming practices. Data presentation component 1420 includes a food browser that is a generic representation engine that allows a user to browse through the history and other related food bundle data. The food browser can hold any number of food bits tokens that can be used to access proprietary information on the blockchain. Data automation component 1422 enables information to be stored on the blockchain of food as smart data. Because information on the blockchain is tokenized, any participant can use this infrastructure to automate processes in real time and license the results of the computations to other users of the system.

FIG. 15 is a high level block diagram of the architecture that maybe used to implement the disclosed system. Most of the components and processes represented in FIG. 15 are described in detail above. FIG. 15 shows a blockchain of food 1502, as described above. Coupled to the blockchain of food 1502 are the following components: FOOD BUNDLES 1504, contracts 1506, assertions 1508, certifications 1510, and evidence 1512, all of which are described in detail above. A web of trust 1514 (described in detail above) is shown connecting various components of the system. System core analytics and UI engines 1516 provide an interface between the blockchain of food and various profiles components 1518. The system core analytics and UI engines 1516 includes user interface management, smart contract management, and keys management. The profile components 1518 interface with stakeholder components 1520, for interfacing with stakeholders such as farmers, distributors, processors, restaurants, retailers, and consumers using one or more software applications 1522.

A system integration engine 1524 provides an interface between evidence component 1512 and various components 1526. The system integration engine 1524 includes vendor-specific connectors, public blockchain of food API, and ontology and data standardization. The components 1526 include a crop connect component, various export components, ADI models, consumer physics component, USDA certifiers, and third party databases. Various of the components 1526 are connected to Internet 1528. Various stakeholder components 1530 can interface with the system via Internet 1528. For example, sensors used by farmers, transporters, distributors, and processors can connect to the system via Internet 1528. Similarly, retailers and consumers can interface with the system over Internet 1528.

FIG. 16 is a functional block diagram illustrating the use of food bit tokens, in the context of two use cases “Use Case 1” and “Use Case 2.” Generally, food bit tokens facilitate the exchange of payments across a supply chain. The food bit token allows for micro-payments tied to data usage, consumption, licensing, etc. This can be used as an incentive for food industry players to share information with one another on the blockchain of food. Secondary exchanges allow the exchange of food bits with US dollars or other currencies. Therefore, food bit tokens will have a value relating to US dollars, allowing supply chain players to cash out their tokens at any time.

In use case 1, a food producer publishes a statement about the value they add to a food product. For example, a food manufacturer may claim to use non-GMO seeds, a farmer may claim to use organic farming practices, a packer claims to use only recycled materials, or a restaurant claims to use quality score certification. In use case 2, a food producer wants to share information securely with another supply chain player. For example, a food producer may want to share ADI CropConnect sensor data, a distributor may want to share provenance info, a grower may want to share practices and processes, or the producer may want to share equality and provenance certifications.

In either use case, decryption keys are created for the purpose of facilitating the exchange of tokens. A relevant food bundle contains information about a food item, is linked to optional parent bundles, is linked to assertions and certifications, and may contain private encrypted data. The food browser holds a user's food bit tokens and keys, as well as aggregating food bundle history/parentage. The food browser also applies ontology stylesheets to bundle JSON. The food browser may contain private encrypted data. The food browser is accessible to both the enterprise systems as well as the end-user. End-user benefits include: smart applications with an integrated food browser, visibility into food provenance and food quality information, access to any information posted publicly by producers on the chain, large datasets/files can be stored on secondary secure data networks, and feedback from end-users back to the supply chain is allowed. Enterprise system integration examples includes: smart menu integration at restaurants matches a user's peanut allergy, digital dashboards and grocery stores display product food miles, distribution center purchasing system certifies provenance, a farmer purchases crop plan recommendations from a third-party, and an NGO agency certifies fair trade assertions from a global distributor.

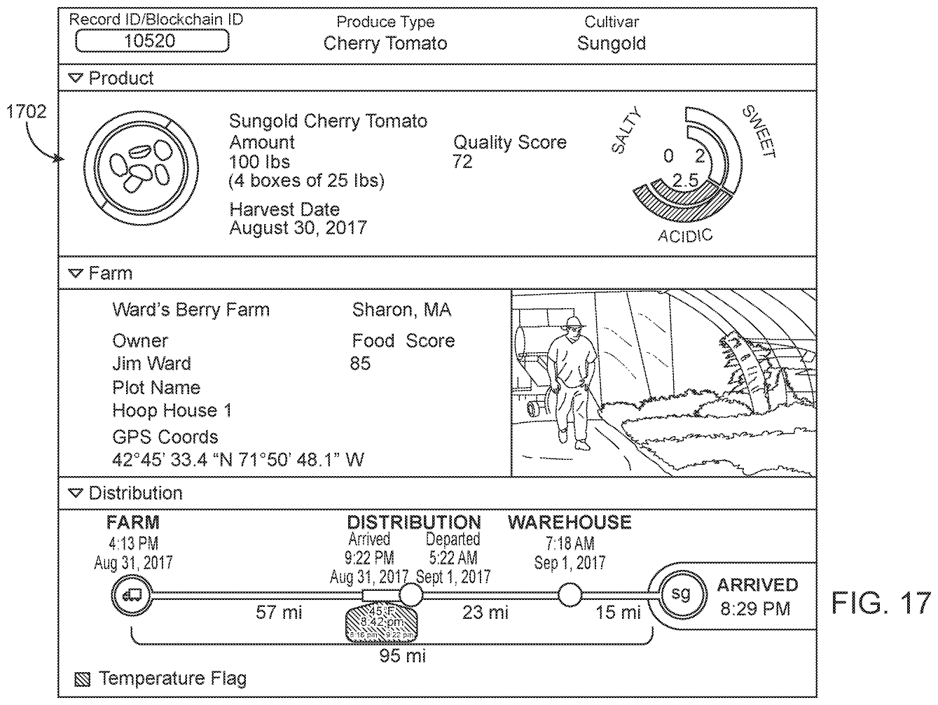

As discussed above, the disclosed system is capable of collecting, creating, and recording an enormous amount of data. FIG. 17 is a screenshot of one example of a dashboard showing a summary of data collected for a particular batch of produce. The exemplary screenshot of FIG. 17 shows a dashboard 1702 relating to the supply chain of a batch of tomatoes. The dashboard includes a Record ID/Blockchain ID, identifying a particular FOOD BUNDLE. The dashboard indicates that this records relates to a quantity of Sungold Cherry Tomatoes. The dashboard includes various information about the produce, including the quantity (by weight), the harvest date, a quality score, and a taste indicator (showing scores of acidity, sweetness, and saltiness). The dashboard also includes various information about the farm, including the location, owner, and plot name. The bottom portion of the dashboard page shows information relating to the product distribution. The distribution information shows when the produce was picked up and when it was delivered. The distribution information includes a timeline showing stops at a distribution center and warehouse, including the total miles between each stop and the relevant dates and times. The dashboard also shows a temperature-triggered flag, including the time, location, and sensed temperature that triggered the flag. In this example, a temperature sensor in a truck indicated that the temperature reached 45 degrees F., which is above the threshold of a programmed temperature flag. Other dashboards can be configured to display any desired information relating to any part of the food supply chain.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

### REFERENCES

National Resource Defense Council. “Food Miles.” November 2007. https://food-hub. org/files/resources/Food%20Miles.pdf
Center for Urban Education about Sustainable Agriculture. “How Far Does Your Food Travel to Get to Your Plate?” Date Accessed Mar. 2 2017. http://www.cuesa.org/learn/how-far-does-your-food-travel-get-your-plate
Gunders, D. “Wasted: How America Is Losing Up to 40 Percent of Its Food from Farm to Fork to Landfill” National Resource Defense Council, August 2012. https://www.nrdc.org/sites/default/files/wasted-food-IP.pdf
Fernandez, A. “A Holistic Approach To Traceability” Jun. 15, 2015. Food Quality and Safety. http://www.foodqualityandsafety.com/article/ a-holistic-approach-to-traceability/US
US Food and Drug Administration. “Food Safety Modernization Act” Date Accessed Mar. 2 2017. http://www.fda.gov/Food/GuidanceRegulation/FSMA/ucm270851.htm
USDA Economic Research Service. “Organic Market Overview” Oct. 19 2016. https://www.ers.usda.gov/topics/natural-resources-environment/organic-agriculture/organic-market-overview.aspx
Schweizer, E. “Organic and Non GMO Market Growth.” 2015. https://www.aphis.usda. gov/stakeholders/downloads/2015/coexistence/Errol-Schweizer.pdf.
The Regeneration Consumer Study. “Re:Thinking Consumption” 2012. http://www. globescan.com/component/edocman/?task=document.viewdoc&id=51&Itemid&Itemid=0.
Fernandez, A. “Traceability Update: Regulatory and Cultural Trends Shift from Response to Prevention” March 2015. http://www.foodsafetymagazine.com/magazine-archive1/februarymarch-2015/traceability-update-regulatory-and-cultural-trends-shift-from-response-to-prevention/.
Nakamoto, S. “Bitcoin: A Peer-to-Peer Electronic Cash System.” https://bitcoin.org/bitcoin.pdf
Wikipedia. “Proof of Stake.” https://en.wikipedia.org/wiki/Proof-of-stake.
Wikipedia. “Web of Trust.” https://en.wikipedia.org/wiki/Web_of_trust.
Wikipedia. “Smart Contract.” https://en.wikipedia.org/wiki/Smart_contract.

1. (canceled)

2. The system of claim 19, further comprising selectively providing access to the one or more blockchain ledgers to one or more users.

3. The system of claim 19, further comprising implementing one or more automated routines on the food supply data system.

4. The system of claim 3, further comprising automatically triggering the execution of the one or more automated routines based on data and events stored by the one or more blockchain ledgers.

5. The system of claim 4, wherein one of the automated routines relates to the automatic generation of an invoice.

6. The system of claim 4, wherein one of the automated routines relates to the operation of an irrigation system.

7. The system of claim 4, wherein one of the automated routines relates to the operation of a transportation system.

8. The system of claim 19, wherein the one or more sensors includes at least one temperature sensor for sensing the temperature of the unit of food during transportation.

9. The system of claim 8, further comprising generating an alert based on the sensed temperature.

10. The system of claim 19, wherein the one or more sensors includes at least one moisture sensor for sensing the moisture level in a field.

11. The system of claim 10, further comprising optimizing water usage in an irrigation system based on the sensed moisture in the field.

12. The system of claim 19, further comprising receiving manually entered data and storing the manually entered data using the one or more blockchain ledgers.

13. The system of claim 12, wherein the manually entered data relates to the profile of a farmer.

14. The system of claim 12, wherein the manually entered data relates to farming practices of a farmer.

15. The system of claim 19, further comprising selectively encrypting data stored by the one or more blockchain ledgers.

16. The system of claim 19, further comprising, for a given unit of food, generating a scorecard for the given unit of food, wherein the scorecard provides a score for the given unit of food based on a plurality of product and process variables.

17. (canceled)

18. (canceled)

19. A food supply data system associated with a food supply chain, the food supply data system comprising:
a processor; and
a non-transitory computer readable medium comprising computer code for processing food supply chain data, the computer code comprising code for:
providing a user interface to a client device, the user interface having one or more input fields for food supply chain users to provide information relating to units of food in the food supply chain;
receiving over a network information provided by a food supply chain user relating to a unit of food in the food supply chain;
responsive to receiving information provided by the food supply chain user, creating a unique identifier comprising a virtual representation of the unit of food in the food supply chain;
capturing, by the food supply data system, assertion transactions associated with the unit of food, the assertion transactions comprising claims relating to the unit of food made by one or more users of the food supply chain;
capturing, by the food supply data system, evidence transactions associated with the unit of food from one or more sensors distributed in the food supply chain, the evidence transactions comprising information relating to sensed conditions associated with the unit of food;
capturing, by the food supply data system, certification transactions associated with the unit of food, the certification transactions each comprising a third-party validation of one or more of the assertion transactions, validating the authenticity of the respective assertion transaction;
storing data relating to the unit of food in one or more blockchain ledgers, the stored data including the unique identifier and associated assertion transactions, evidence transactions, and certification transactions; and
generating a responsive user interface in response to requests by food supply chain users to display information relating to the unit of food including current and historical information about the unit of food.

20. The system of claim 19, further comprising configuring a token mechanism to enable originators of captured data to control access to the respective captured data.

21. The system of claim 19, further comprising configuring a web-of-trust network to control information exchange among food supply chain users.

22. A method for processing food supply chain data in a food supply data system, the method comprising:
providing a user interface to a client device, the user interface having one or more input fields for food supply chain users to provide information relating to units of food in a food supply chain;
receiving over a network information provided by a food supply chain user relating to a unit of food in the food supply chain;
responsive to receiving information provided by the food supply chain user, creating a unique identifier comprising a virtual representation of the unit of food in the food supply chain;
capturing, by the food supply data system, assertion transactions associated with the unit of food, the assertion transactions comprising claims relating to the unit of food made by one or more users of the food supply chain;
capturing, by the food supply data system, evidence transactions associated with the unit of food from one or more sensors distributed in the food supply chain, the evidence transactions comprising information relating to sensed conditions associated with the unit of food;
capturing, by the food supply data system, certification transactions associated with the unit of food, the certification transactions each comprising a third-party validation of one or more of the assertion transactions, validating the authenticity of the respective assertion transaction;
storing data relating to the unit of food in one or more blockchain ledgers, the stored data including the unique identifier and associated assertion transactions, evidence transactions, and certification transactions; and
generating a responsive user interface in response to requests by food supply chain users to display information relating to the unit of food including current and historical information about the unit of food.

23. A non-transitory computer readable medium, comprising instructions for:
providing a user interface to a client device, the user interface having one or more input fields for food supply chain users to provide information relating to units of food in a food supply chain;
receiving over a network information provided by a food supply chain user relating to a unit of food in the food supply chain;
responsive to receiving information provided by the food supply chain user, creating a unique identifier comprising a virtual representation of the unit of food in the food supply chain;
capturing, by a food supply data system, assertion transactions associated with the unit of food, the assertion transactions comprising claims relating to the unit of food made by one or more users of the food supply chain;
capturing, by the food supply data system, evidence transactions associated with the unit of food from one or more sensors distributed in the food supply chain, the evidence transactions comprising information relating to sensed conditions associated with the unit of food;
capturing, by the food supply data system, certification transactions associated with the unit of food, the certification transactions each comprising a third-party validation of one or more of the assertion transactions, validating the authenticity of the respective assertion transaction;
storing data relating to the unit of food in one or more blockchain ledgers, the stored data including the unique identifier and associated assertion transactions, evidence transactions, and certification transactions; and
generating a responsive user interface in response to requests by food supply chain users to display information relating to the unit of food including current and historical information about the unit of food.
